(19) United States
(12) Patent Application Publication
(10) Pub. No.: US 2026/0245593 A1
(43) Pub. Date: Aug. 20, 2026

(54) ELECTRONIC DEVICE FOR PROVIDING CONTENT EDITING-RELATED INFORMATION, OPERATION METHOD THEREOF, AND STORAGE MEDIUM

(71) Applicants: SAMSUNG ELECTRONICS CO., LTD., Suwon-si (KR); SAMSUNG ELECTRONICS CO., LTD., Suwon-si (KR)

(72) Inventors: Bohyun LEE, Suwon-si (KR); Jihyun Kim, Suwon-si (KR); Bosung Kim, Suwon-si (KR); Hyunsoo Kim, Suwon-si (KR); Jiyoon Park, Suwon-si (KR)

(21) Appl. No.: 19/643,098

(22) Filed: Apr. 9, 2026

Related U.S. Application Data
(63) Continuation of application No. PCT/KR2024/012139, filed on Aug. 14, 2024.

(30) Foreign Application Priority Data
Oct. 10, 2023 (KR) 10-2023-0134123
Nov. 14, 2023 (KR) 10-2023-0157154

(51) Int. Cl. G11B 27/34; G06V 20/40; G10L 17/22; G11B 27/031

(52) U.S. Cl. CPC G11B 27/34; G06V 20/41; G10L 17/22; G11B 27/031

(57) ABSTRACT

One or more embodiments may provide an electronic device including: a microphone; a camera; at least one processor; and memory storing instructions configured to, when executed by the at least one processor individually or collectively, cause the electronic device to: obtain, using the camera, video data, obtain, using the microphone, audio data while obtaining the video data, identify, based on the audio data, a voice associated with a user identify, based on voice-recognized text associated with the voice, a memo associated with content editing, and store content that includes: the video data, the audio data from which the voice has been removed, and the memo.

### CROSS-REFERENCE TO RELATED APPLICATION(S)

This application is a continuation application, claiming priority under 35 U.S.C. § 365 (c), of an International application No. PCT/KR2024/012139, filed on Aug. 14, 2024, which is based on and claims the benefit of a Korean patent application number 10-2023-0134123, filed on Oct. 10, 2023, in the Ministry of Intellectual Property (MOIP), and of a Korean patent application number 10-2023-0157154, filed on Nov. 14, 2023, in the Ministry of Intellectual Property (MOIP), the disclosure of each of which is incorporated by reference herein in its entirety.

### BACKGROUND

### 1. Field

One or more embodiments of the present disclosure may relate to an electronic device for providing information related to content editing, an operating method thereof, and a storage medium.

### 2. Description of Related Art

As the prevalence, hardware, and functionality of electronic devices such as smartphones continues to progress and evolve, various applications are being developed that may be used in conjunction therewith.

For example, an increasing number of users are using various camera applications and programs on their electronic devices to capture and enjoy both video and photographic images, which may be referred to as user created contents (UCC). Furthermore, there is a growing need for users to share their UCC via a social network service (SNS). When capturing video (e.g., recording or sound recording) using a camera of an electronic device in various environments, both the video and ambient sound (or audio) including the voice of a person capturing may be recorded together. Accordingly, there is an increasing demand for camera applications that realize both enhanced editing capabilities, as well as improved accessibility and retrieval of specific portions within captured video content.

### SUMMARY

One or more embodiments of the present disclosure may provide an electronic device including: a microphone; a camera; at least one processor; and memory storing instructions configured to, when executed by the at least one processor individually or collectively, cause the electronic device to: obtain, using the camera, video data, obtain, using the microphone, audio data while obtaining the video data, identify, based on the audio data, a voice associated with a user identify, based on voice-recognized text associated with the voice, a memo associated with content editing, and store content that includes: the video data, the audio data from which the voice has been removed, and the memo.

One or more embodiments of the present disclosure may provide a method for providing information related to content editing in an electronic device, the method including: obtaining, using a camera, video data; obtaining, using a microphone, audio data while obtaining the video data; identifying, based on the audio data, a voice associated with a user; identifying, based on voice-recognized text associated with the voice, a memo associated with content editing; and storing content that includes: the video data, the audio data from which the voice has been removed, and the memo.

One or more embodiments of the present disclosure may provide a non-transitory storage medium storing instructions configured to, when executed by at least one processor that is communicatively coupled with an electronic device, cause the electronic device to perform at least one operation, wherein the at least one operation includes: obtaining, using a camera, video data; obtaining, using a microphone, audio data while obtaining the video data; identifying, based on the audio data, a voice associated with a user; identifying, based on voice-recognized text associated with the voice, a memo associated with content editing; and storing content that includes: the video data, the audio data from which the voice has been removed, and the memo.

### BRIEF DESCRIPTION OF DRAWINGS

FIG. 1 is a block diagram illustrating an electronic device in a network environment according to one or more embodiments.

FIG. 2A is a view illustrating a method of identifying a user's voice during content capturing according to one or more embodiments.

FIG. 2B is an internal block diagram illustrating an electronic device according to one or more embodiments.

FIG. 3 is a detailed internal block diagram illustrating an electronic device for providing information related to content editing according to one or more embodiments.

FIG. 4 is an operation flowchart of an electronic device for providing information related to content editing according to one or more embodiments.

FIG. 5 is a detailed operation flowchart of an electronic device for providing information related to content editing according to one or more embodiments.

FIG. 6 is a conceptual view illustrating one or more embodiments of generating and storing a memo related to editing based on a user's voice during content capturing according to one or more embodiments.

FIG. 7 is a view illustrating a component for determining a condition for tagging information related to content editing according to one or more embodiments.

FIG. 8A is a screen example view for describing a first method of displaying a memo associated with content editing according to one or more embodiments.

FIG. 8B is a screen example view for describing a second method of displaying a memo associated with content editing according to one or more embodiments.

FIG. 9A is a screen example view for describing a first method of modifying a memo associated with content editing according to one or more embodiments.

FIG. 9B is a screen example view for describing a second method of modifying a memo associated with content editing according to one or more embodiments.

FIG. 9C is a screen example view for describing a third method of modifying a memo associated with content editing according to one or more embodiments.

In connection to the description of the drawings, identical or similar reference numerals may be used for identical or similar components.

### DETAILED DESCRIPTION

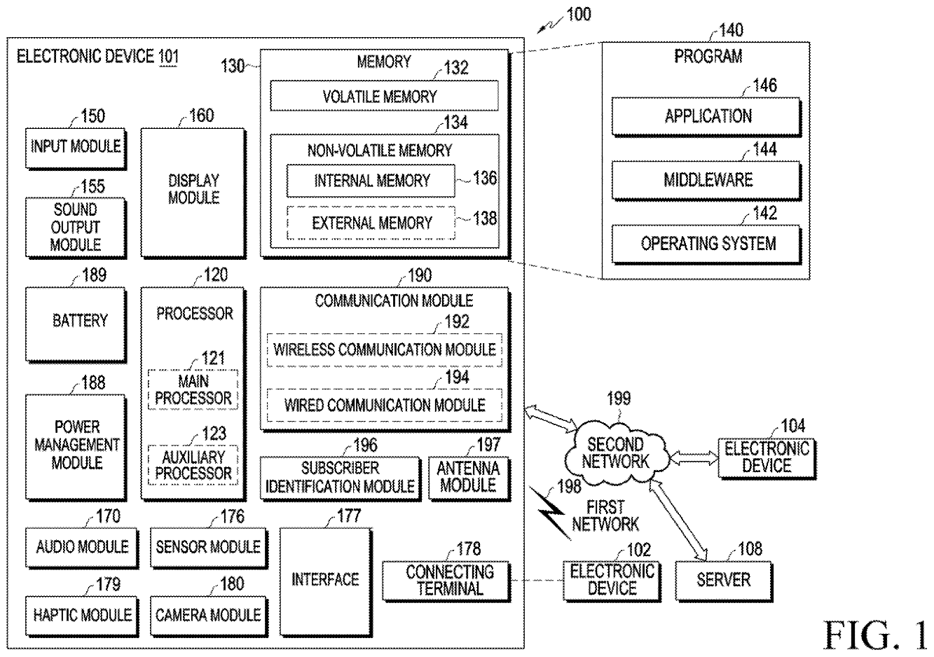

FIG. 1 is a block diagram illustrating an electronic device 101 in a network environment 100 according to various embodiments. Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to one or more embodiments, the electronic device 101 may communicate with the electronic device 104 via the server 108. According to one or more embodiments, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In one or more embodiments, at least one (e.g., the connecting terminal 178) of the components may be omitted from the electronic device 101, or one or more other components may be added in the electronic device 101. According to one or more embodiments, some (e.g., the sensor module 176, the camera module 180, or the antenna module 197) of the components may be integrated into a single component (e.g., the display module 160).

The processor 120 may execute, for example, software (e.g., the program 140) to control at least one other component (e.g., a hardware or software component) of the electronic device 101 coupled with the processor 120, and may perform various data processing or computation. According to one or more embodiments, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to one or more embodiments, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to one or more embodiments, the auxiliary processor 123 (e.g., an image signal processor or a communication processor) may be implemented as part of another component (e.g., the camera module 180 or the communication module 190) functionally related to the auxiliary processor 123. According to one or more embodiments, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to one or more embodiments, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to one or more embodiments, the display module 160 may include a touch sensor configured to detect a touch, or a pressure sensor configured to measure the intensity of a force generated by the touch.

The audio module 170 may convert a sound into an electrical signal and vice versa. According to one or more embodiments, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an external environmental state (e.g., the user's state), and then generate an electrical signal or data value corresponding to the detected state. According to one or more embodiments, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to one or more embodiments, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to one or more embodiments, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to one or more embodiments, the haptic module 179 may include, for example, a motor, a piezoelectric element, or an electric stimulator.

The camera module 180 may capture a still image or moving images. According to one or more embodiments, the camera module 180 may include one or more lenses, image sensors, image signal processors, or flashes.

The power management module 188 may manage power supplied to the electronic device 101. According to one or more embodiments, the power management module 188 may be implemented as at least part of, for example, a power management integrated circuit (PMIC).

The battery 189 may supply power to at least one component of the electronic device 101. According to one or more embodiments, the battery 189 may include, for example, a primary cell which is not rechargeable, a secondary cell which is rechargeable, or a fuel cell.

The communication module 190 may support establishing a direct (e.g., wiredly) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wiredly) communication or a wireless communication. According to one or more embodiments, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to one or more embodiments, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to one or more embodiments, the antenna module 197 may include one antenna including a radiator formed of a conductor or conductive pattern formed on a substrate (e.g., a printed circuit board (PCB)). According to one or more embodiments, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to one or more embodiments, other parts (e.g., radio frequency integrated circuit (RFIC)) than the radiator may be further formed as part of the antenna module 197.

According to various embodiments, the antenna module 197 may form a mmWave antenna module. According to one or more embodiments, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to one or more embodiments, instructions or data may be transmitted or received between the electronic device 101 and the external electronic device 104 via the server 108 coupled with the second network 199. The external electronic devices 102 or 104 each may be a device of the same or a different type from the electronic device 101. According to one or more embodiments, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In one or more embodiments, the external electronic device 104 may include an internet-of-things (IoT) device. The server 108 may be an intelligent server using machine learning and/or a neural network. According to one or more embodiments, the external electronic device 104 or the server 108 may be included in the second network 199. The electronic device 101 may be applied to intelligent services (e.g., smart home, smart city, smart car, or healthcare) based on 5G communication technology or IoT-related technology.

In the following description, components of the above embodiments may be denoted with or without the same reference numerals and their detailed description may be skipped. According to one or more embodiments of the disclosure, an electronic device 101 may be implemented by selectively combining configurations of various embodiments, and the configuration of one embodiment may be replaced by the configuration of another embodiment. However, it is noted that the disclosure is not limited to a specific drawing or embodiment.

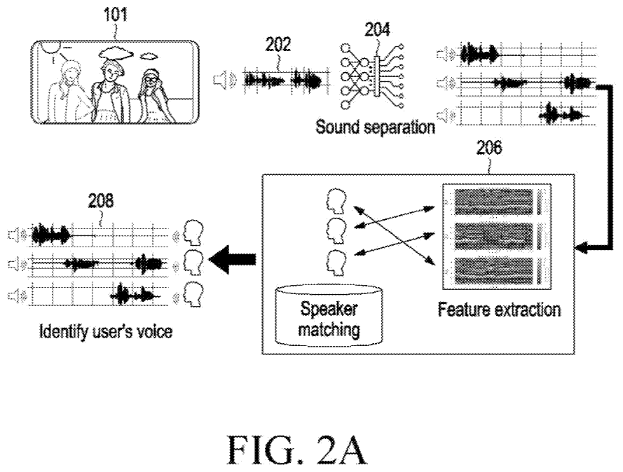

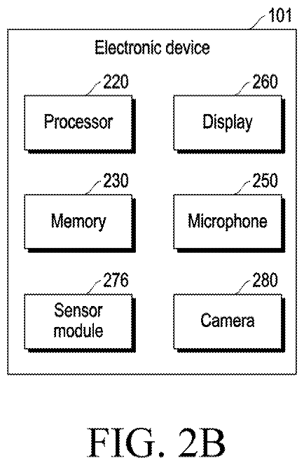

Before describing the disclosure, a method for separating a voice signal in content, used in the disclosure, is described with reference to FIG. 2A. FIG. 2A is a view illustrating a method of identifying a user's voice during content capturing according to one or more embodiments.

The types of content provided by an electronic device 101 are becoming diverse, and the content may be, e.g., video content captured by a user. In the following description, the content includes a visual image and an audible sound, and may be, e.g., content including an image and an audio including a person. Here, the video may refer to moving video, and voice may also be described as audio or sound.

Referring to FIG. 2A, during content capturing by a camera in the electronic device 101, a voice signal 202 including the voice of at least one speaker may be received through a microphone. For example, in a case of a plurality of speakers, voice signals 202 may be separated based on sound separation technology 204. The electronic device 101 may identify the speaker through voice feature extraction for each of the separated voice signals and perform matching 206 to the identified speaker.

Specifically, the electronic device 101 may identify (or separate) at least one voice signal in the content and identify 208 a user's voice by comparing the identified voice signal with a pre-stored voice signal of the user. As such, the electronic device 101 may separate a voice signal in the content and may match the separated voice signal to a user through learning such as deep learning. According to one or more embodiments, the electronic device 101 may separate a voice signal corresponding to a user utterance in the content, and may provide information related to a user voice input through voice recognition for the separated voice signal. For example, a user voice input received during capturing may be regarded as a user input for a portion that the user wants to edit. Accordingly, the electronic device 101 may convert data related to the user voice input received during capturing into text data and may provide information summarizing the text data as information about a portion that the user wants to edit in the captured video content.

In one or more embodiments, for the content captured by the electronic device 101, providing information about a portion that the user wants to edit based on the user voice input received during capturing relates to an electronic device for providing information related to content editing, an operating method thereof, and a storage medium.

According to one or more embodiments, from the user's perspective, what the user uttered in real-time about the content during content capturing may be used as information for emphasizing a portion including important content or for a portion to be edited, without stopping capturing. Further, the electronic device 101 may remove the user's voice when storing the content, tag information related to content editing based on the user's voice on the corresponding portion in the captured content, and then store the content. Accordingly, the content from which the user's voice has been removed may be played back, and immersion or experience in viewing the content may be enhanced.

According to one or more embodiments, the electronic device 101 may provide information related to content editing tagged on the corresponding portion in the content when playing back the stored content, thereby supporting not only more convenient and intuitive search and playback functions but also an editing function for a desired content section. Accordingly, the user may easily edit desired content on the electronic device 101 without using a separate program for content editing, and user convenience may be increased.

In the following description, what the user (e.g., a person capturing) uttered during content capturing is used as information for emphasizing a portion including important content or for a portion to be edited, and such information associated with content editing may be referred to as a memo. A memo refers to a short note, so information associated with content editing may also be referred to as a note. Further, the memo may include, e.g., a keyword in the content.

FIG. 2B is an internal block diagram illustrating an electronic device according to one or more embodiments.

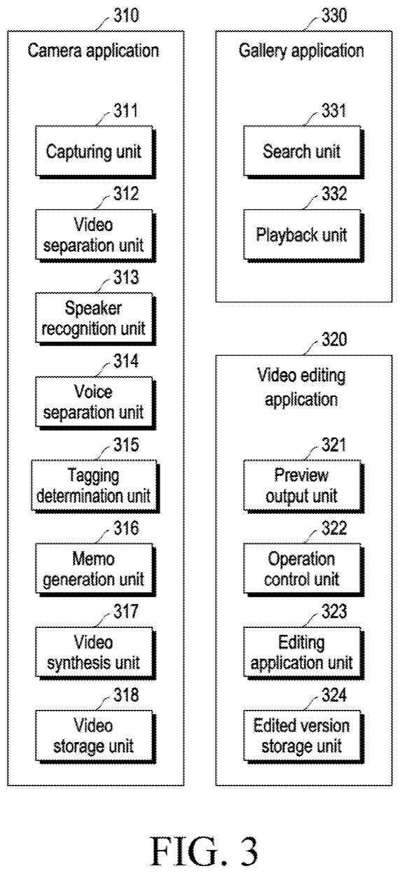

Referring to FIG. 2B, the electronic device 101 may include at least one processor 220, memory 230, a microphone 250, and/or a camera 280. According to one or more embodiments, the electronic device 101 may further include a display 260 and/or a sensor module 276. The electronic device 101 of FIG. 2B may be the electronic device 101 of FIG. 1. Here, not all components illustrated in FIG. 2B are essential components of the electronic device 101, and the electronic device 101 may be implemented with more or fewer components than those illustrated in FIG. 2B. Further, the description of FIG. 2B is made with reference to FIG. 3. FIG. 3 is a detailed internal block diagram illustrating an electronic device for providing information related to content editing according to one or more embodiments.

Referring to FIGS. 2B and 3, when a camera application (e.g., a program or function) 310 for content capturing is executed, the processor 220 may control a capturing unit 311 to be driven. For example, when an input by an execution icon (e.g., an object, a graphic element, a menu, a button, or a shortcut image) (not illustrated) representing a camera application displayed on a home screen (not illustrated) of the display 260, a designated button input, or an input by a designated gesture is received, the processor 220 may identify that there is a content capturing request and may execute the camera application.

According to one or more embodiments, the processor 220 may control to activate at least one camera 280 according to the execution of the camera application 310 to perform content capturing. The processor 220 may control the display 260 to display a preview screen during content capturing. For example, when a recording command is received while the preview screen is displayed, the processor 220 may initiate recording based on the preview screen and may activate at least one microphone 250 to receive an audio signal (or sound signal) corresponding to sound occurring from the user, a subject, and/or the surroundings of the subject. Hereinafter, content capturing may represent content recording.

According to one or more embodiments, the processor 220 may obtain audio data using the microphone 250 while obtaining video data using the camera 280. The processor 220 may identify a user's voice for at least part of the audio data. The audio data used to identify the user's voice may be separated or extracted from the captured data.

According to one or more embodiments, the processor 220 (or a video separation unit 312) may separate captured data (or content) into video data and audio data during content capturing. According to one or more embodiments, the processor 220 may extract video data and audio data using the captured data. For example, the processor 220 may extract audio data in preset section units from the captured data and may determine a voice section composed of the extracted audio data. The processor 220 may use the determined voice section to identify the user's voice and analyze the linguistic meaning of the identified user's voice. Further, the processor 220 may extract a portion of video data (or at least one video frame) in a time sequence based on a preset frame rate (frames/second) from the captured data and may determine a video section composed of the extracted portion of video data. The processor 220 may use the determined video section to detect a designated object or an action of a designated object.

In FIG. 3, each component, e.g., a speaker recognition unit 313, may be provided in the electronic device 101 in the form of one ‘module’ or ‘unit’, or may be provided in the memory 230 in a software form. Further, the speaker recognition unit 313 may drive a voice recognition engine to which a voice recognition algorithm is applied to recognize a user's voice input through the microphone 250. For example, the speaker recognition unit 313 may convert an audio signal (or audio data) input through the microphone 250 into digital data, amplify the digital data, and then identify whether it is a person's voice. If the audio signal corresponds to a person's voice, the speaker recognition unit 313 may detect the start time and end point of the voice. Here, the speaker recognition unit 313 may identify whether the voice corresponds to the user's voice in a voice recognition database stored in the memory 230. In this case, the speaker recognition unit 313 may perform speaker recognition using at least one feature value among waveform, format, or pitch of the audio data input from the microphone 250.

According to one or more embodiments, after identifying the user's voice, the processor 220 (or a voice separation unit 314) may separate the audio data into audio data corresponding to the user's voice and remaining audio data except for the user's voice.

According to one or more embodiments, the processor 220 (or a tagging determination unit 315) may interpret the voice signal of the user and determine data required for tagging. For example, the processor 220 may perform voice recognition on the audio data corresponding to the user's voice through a voice recognition engine (or a voice recognition module) stored in the memory 230. Alternatively, the processor 220 may execute an intelligent app to process the user voice input through a server 108 (e.g., an intelligent server). In this case, e.g., the processor 220 may recognize an utterance or a voice input of the user received through the microphone 250 and may convert the recognized voice input into text. According to one or more embodiments, voice recognition processing for the user's utterance may partially include automatic speech recognition (ASR) and/or natural language understanding (NLU) processing. For example, the ASR module (or ASR engine) may be used to convert the user's speech into text, and the NLU module (or NLU engine) may extract the meaning of the user utterance from the recognition result of the ASR module.

According to one or more embodiments, the processor 220 may obtain voice-recognized text for at least part of data uttered by the user. For example, the voice recognition engine may perform syntactic analysis or semantic analysis on the voice-recognized text to understand the user's intent. For example, using the voice recognition engine, the processor 220 may understand the meaning of a word extracted from a voice input using linguistic features (e.g., grammatical elements) of a morpheme or a phrase and may determine the user's intent by matching the understood meaning of the word to an intent. By determining the intent corresponding to the voice in this way, the meaning of the user's utterance may be extracted.

According to one or more embodiments, the processor 220 may analyze the linguistic meaning of a voice section and may identify (or extract) a preset keyword or an important keyword in the voice section. For example, keyword identification (or keyword extraction) may mean extracting a word that may represent a text composed of a plurality of words through voice recognition. The keyword may be used for easily understanding the content of an utterance or for searching in the future. The processor 220 may extract one word representing the content of the utterance, but may also extract and provide two or more words having high importance.

For example, based on a result of analyzing the user's voice, the tagging determination unit 315 may determine that data is required for tagging and may provide the data required for tagging to a memo generation unit 316 together with time information of the user's utterance time. Here, the time information (e.g., a timestamp) of the user's utterance time may include a start time and/or an end time of a voice section corresponding to the user's utterance.

Accordingly, based on a result of analyzing the user's voice, the processor 220 (or the memo generation unit 316) may generate a memo summarizing the content of the user's utterance. The memo summarizing the content of the user's utterance may include a word and/or a sentence having an intent related to content editing, and thus may be referred to as a content editing-related memo. For example, using a voice recognition engine learned through learning such as deep learning, the processor 220 may identify a user utterance required for tagging. Accordingly, the processor 220 may summarize the content of the user's utterance determined to require tagging using the voice recognition engine and may generate a memo in the form of text representing the summarized utterance content. Here, the memo in the form of text may be generated based on a word summarizing the content of the user's utterance, a keyword included in the voice-recognized text, or a first recognized word, and it is apparent to those skilled in the art that the method of determining the content included in the memo may vary.

According to one or more embodiments, the processor 220 (or a video synthesis unit 317) may synthesize video data and audio data except for the user's voice. If audio data is extracted in preset section units from the captured data and then voice recognition is performed on the audio data corresponding to the user's voice, an operation of synthesizing video data and audio data may not be performed. For example, the processor 220 may combine (or add) audio data except for the user's voice with the video data and store the same.

According to one or more embodiments, the processor 220 (or a video storage unit 318) may tag and store the generated memo and the time information on data obtained by synthesizing the video data and the audio data except for the user's voice. For example, the user voice-based memo may be stored by mapping the memo to time information including a start time and/or an end time of a section in which the user's voice is recognized. Further, the user voice-based memo and time information may be tagged and stored on the corresponding section in the content when storing the content. Therefore, when content capturing ends, the processor 220 may store content including the video data obtained through the camera 280, the audio data from which the user's voice has been removed, and the memo in the memory 230. For example, the processor 220 may tag the memo on a section corresponding to the time information of the video data and may store content including the video data on which the memo is tagged and the audio data except for the user's voice in the memory 230.

Meanwhile, although a case of identifying the user's voice using the voice recognition engine has been described as an example in the foregoing, the processor 220 (or the speaker recognition unit 313) may detect the direction of sound or external sound through at least one microphone 250. Therefore, the processor 220 may identify the user's voice by identifying the direction of a voice signal received through at least one microphone 250 when the user utters. For example, assuming that the user captures while holding the electronic device 101, a voice signal received from a direction facing the display 260 may be identified as the user's voice.

In one or more embodiments, a case of generating a text memo using voice-recognized text based on the user's voice in generating a content editing-related memo during content capturing is described as an example, but the type of the content editing-related memo may not be limited thereto. For example, the processor 220 may use a portion of the user's voice itself to generate the content editing-related memo without converting the user's voice into text through voice recognition. The processor 220 may identify the user's voice among audio data input through the microphone 250 and then generate a portion of the identified user's voice as a voice memo. Further, the processor 220 may generate a designated object or an action of a designated object detected in a portion of the extracted video data as a memo such as a thumbnail image. As such, the content editing-related memo may include at least one of a text memo, a voice memo, or a thumbnail image memo, and the type thereof may not be limited thereto.

Meanwhile, although a case of generating a text memo using voice-recognized text based on the user's voice in generating a content editing-related memo during content capturing has been described as an example in the foregoing, audio data such as a voice of a bystander or other noise other than the user's voice may be used to generate the content editing-related memo. Therefore, the type of data used to generate the content editing-related memo is not limited thereto, and a detailed description thereof is given later.

According to one or more embodiments, the processor 220 may support a function of generating a user voice-based memo during content capturing (or recording). For example, after content capturing starts, the processor 220 may perform an operation of analyzing the meaning of a voice section for audio data input through the microphone 250 at regular time intervals and generating a user voice-based memo based on a result of analyzing the voice section.

Meanwhile, if voice recognition is always possible during content capturing, the voice recognition rate may be lowered due to ambient noise occurring during capturing. Therefore, when a user input for leaving a memo is received during content capturing, the voice recognition mode may be activated to increase the voice recognition rate. To this end, the processor 220 may perform an operation of activating the voice recognition mode and generating a user voice-based memo in response to receiving a designated voice command, a designated touch input, or an input through a hardware key (e.g., a dedicated hardware key) during content capturing.

According to one or more embodiments, after activating the voice recognition mode, the processor 220 may identify the user's voice from audio data received through the microphone 250. The processor 220 may identify a designated command from the user's voice.

For example, when recognizing a designated command (e.g., a wake-up word (e.g., “hi bixby”)) during content capturing, the processor 220 may identify a first section to be tagged among the video data based on the designated command. The processor 220 may recognize the content of a user's utterance input before or after the designated command is uttered as a voice requiring tagging. Therefore, the processor 220 may generate a memo based on the content of the user's utterance input before or after the designated command is uttered.

According to one or more embodiments, when the user utters during content capturing (e.g., “Okay, let's cut here”), the processor 220 may analyze the meaning of the voice section and, when recognizing a designated voice input (e.g., “Okay”) in the result of analyzing the voice section, the processor 220 may recognize the content of the user's utterance input after the designated voice input as a voice requiring tagging.

According to one or more embodiments, when the user utters during content capturing (e.g., “Now, student Hong Gil-dong will come out and give a presentation.”), the processor 220 may analyze the meaning of the voice section to identify a user intent that the user has input a guidance comment for editing. Therefore, the processor 220 may recognize the guidance comment as a voice requiring tagging.

As described above, the processor 220 may perform an operation of identifying a designated command or a user intent from the user's voice to generate a user voice-based memo.

According to one or more embodiments, when receiving a designated touch input for content editing or an input through a hardware key (e.g., a dedicated hardware key), the processor 220 may initiate an operation of generating a user voice-based memo. In addition to the above, e.g., when an object (e.g., an icon) for executing voice recognition is displayed on a capturing screen and the object is selected, the processor 220 may initiate an operation of driving a voice recognition engine to generate a user voice-based memo. Therefore, a method for activating a voice recognition mode for generating a user voice-based memo may not be limited thereto.

According to one or more embodiments, the processor 220 may generate a content editing-related memo using audio data. The processor 220 may identify a designated audio pattern among the audio data. Here, the designated audio pattern may include an audio pattern such as noise, a cough sound, or a vehicle collision sound. For example, if an audio pattern corresponding to a cough sound of a person appearing in the captured content is detected, the processor 220 may identify that the audio pattern requires tagging for subsequent deletion or editing. Accordingly, based on the identified audio pattern such as “cough sound”, the processor 220 may generate a memo such as “noise identify required (cough sound)”. The processor 220 may identify a second section to be tagged among the video data in response to identifying the designated audio pattern among the audio data corresponding to the user's voice or the remaining audio data except for the user's voice. The processor 220 may tag a memo associated with the designated audio pattern on the identified second section of the video data.

Meanwhile, according to one or more embodiments, the processor 220 may generate a content editing-related memo using video data. The processor 220 may detect a designated object or an action of a designated object using a video recognition engine in at least part of the video data, as illustrated in Table 1 below. For example, if a scene in which a new person appears is detected in at least part of the video data, the processor 220 may identify the scene in which the new person appears as a portion requiring tagging for subsequent editing. For example, when an object corresponding to a cake is detected in at least part of the video data using a video recognition engine, the processor 220 may recognize the scene as a birthday celebration scene among scene recognitions of a summary shot category and may tag a memo such as ‘birthday celebration’ or ‘birthday cake’ on the scene in which the cake appears.

TABLE 1

| | Emotional | Rapid | |
|---|---|---|---|
| Category | connect | motion | Summary shot |
| Detected items | Emotions: | Motion: | Scene recognition: |
| | happy (laugh), | jumping | birthday congratulation, |
| | surprised, | | fireworks in the sky, |
| | sad, | | ring exchange, |
| | excited | | sunrise & sunset, |
| | People count | | play with pet |
| | Actions: | | |
| | holding, | | |
| | kissing, | | |
| | dancing, | | |
| | running, | | |
| | walking, | | |
| | eating | | |
| | Hand gestures: | | |
| | high five, | | |
| | handshake, | | |
| | clapping, | | |
| | waving hands | | |

As such, when a designated object or an action of a designated object is detected, the processor 220 may generate a memo representing the detected object or the action of the object. Further, the processor 220 may generate a memo indicating a scene transition even when a scene transition is detected. Besides, for a preview image obtained through the camera 280, a subject (e.g., an object) currently being displayed may be classified through an AI segmentation map. For example, an object such as a cake, a desk, or a computer may be detected as a meaningful object from the preview image. Further, a designated person or an action of a person may be detected using a facial recognition function. Therefore, the processor 220 may identify a third section to be tagged of the video data related to the detected time. The processor 220 may tag a memo representing the object or the action of the object on the third section to be tagged of the video data.

Further, according to one or more embodiments, the processor 220 may identify a surrounding circumstance based on sensor data obtained through at least one sensor 276. For example, the processor 220 may identify whether the ambient brightness changes by a threshold or more using an illuminance sensor. Further, the processor 220 may identify a user circumstance based on sensor data indicating the tilt and direction of the electronic device 101. For example, when the user starts running suddenly while walking, the processor 220 may detect an action called ‘running’ based on sensor data and may generate a memo based on the corresponding information (‘running action started’). Further, the processor 220 may use the user's location information based on the location information of the electronic device 101 (e.g., an amusement park, a park, or a school) to determine the user's intent for the audio data corresponding to the user's voice. As described above, in response to identifying the surrounding circumstance, the processor 220 may identify a fourth section to be tagged among the video data and may tag a memo associated with the surrounding circumstance on the identified fourth section. As such, the memo is tagged and stored on the captured content when storing the content, and the memo may be stored together with time information (e.g., a timestamp) indicating a time when tagging is determined.

According to one or more embodiments, the memory 230 may store a control program for controlling the electronic device 101, a UI related to an application provided by a manufacturer or downloaded from the outside and images for providing the UI, user information, documents, databases, or related data. For example, the memory 230 may store content including images and audio. The content may be content captured through the execution of a camera application (e.g., a program or function).

According to one or more embodiments, the memory 230 may at least temporarily store at least part of audio data obtained in real-time through the camera application 310 for a next processing operation so that the voice of the user (or speaker) may be identified. For example, the memory 230 may include a video buffer and an audio buffer.

According to one or more embodiments, the audio buffer may store a portion of audio data received through the microphone 250. Further, the video buffer may store a portion of video data obtained through the camera 280.

Meanwhile, in one or more embodiments, a case of tagging a memo summarizing the content of a user's utterance on content captured in real-time through the execution of a camera application (e.g., a program or function) is described as an example, but the type of content on which the memo is tagged may not be limited thereto. For example, when the user utters “Shoot~ Goal!” at a specific moment (e.g., a goal scene) while recording content broadcasting a sports game displayed on the display 260, a memo such as “goal” may be tagged on the corresponding section of the content being recorded. Further, the content may be content such as an internet lecture, a drama, or a movie downloaded or streamed from at least one server 108 (e.g., a content provider). For example, a screen recording function (or application) may record a screen (e.g., video) itself output (or displayed, played back) through the display 260. During screen recording, not only video corresponding to the screen but also sound is recorded together, and for example, content including a user's voice received through the microphone 250 may be recorded. Accordingly, the processor 220 may analyze the meaning of a voice section corresponding to the user's voice while content including the user's voice is being recorded and may generate a user voice-based memo based on a result of analyzing the voice section. As described above, it is apparent to those skilled in the art that the type of content on which a user voice-based memo may be tagged is not limited to content captured in real-time through a camera application.

Meanwhile, when playing back content stored in the memory 230, the processor 220 may provide a content editing-related memo and time information tagged on the corresponding portion in the content. The content editing-related information may be used for content editing, searching, or video section searching. Referring to FIG. 3, a gallery application 330 may include a search unit 331 supporting a search function based on a content editing-related memo and/or a playback unit 332 supporting a playback function. A video editing application 320 may include a preview output unit 321, an operation controller 322, an editing application unit 323, and/or an edited version storage unit 324.

When a user request for content editing is received under the control of the processor 220, the display 260 may display a user interface related to content editing. For example, when a user selection is made for an item (or menu) for content editing displayed on a content playback screen or when a separate app for content editing is executed, the display 260 may display the user interface related to content editing.

According to one or more embodiments, during content editing, the display 260 may display a user interface including an image corresponding to at least one video frame included in the content and objects indicating that a content editing-related memo is tagged on the video frame. An object is a graphic element related to a memo and may include, e.g., an indicator.

According to one or more embodiments, the processor 220 may play back content on which a content editing-related memo is tagged and may support editing the content. Content editing may be provided to the user in an app manner. The app manner may be a manner in which a function for content editing is provided through an application (e.g., the video editing application 320) installed and driven in the electronic device 101.

According to one or more embodiments, the processor 220 (or the preview output unit 321) may extract video frames from the content and may display the extracted video frames in a preview form along a timeline. For example, during content editing, the processor 220 may display content being played back on a portion of the display 260 and may display video frames for the content being played back in a preview form on a remaining portion except for the portion on which the content being played back is displayed. Here, the memo tagged on the timeline of the video frame may be output (or displayed, played back).

According to one or more embodiments, the processor 220 (or the operation controller 322) may provide a function for the user to select a desired time or section among video frames displayed along the timeline. For example, in a state in which video frames are displayed along the timeline, when a tagged memo is selected by the user, the processor 220 (or the operation controller 322) may move and display an indicator indicating the corresponding time or section. Further, when the memo content is modified by the user or a portion of a section of the video frame is modified, the processor 220 (or the editing application unit 323) may display a result to which the modification has been applied in a preview form. The processor 220 (or the edited version storage unit 324) may store the edited content.

According to one or more embodiments, the processor 220 (or the search unit 331) may support a function of searching for a desired scene or section based on a content editing-related memo. For example, when a search word is input by the user in a state in which the gallery application 330 is executed, the processor 220 (or the search unit 331) may search for a content editing-related memo corresponding to the input search word. If a content editing-related memo is searched, the search result may be displayed together with an indicator indicating a section on which the content editing-related memo is tagged. For example, the memo content may be displayed on a screen together with an image of the corresponding section of video data on which the searched content editing-related memo is tagged. Here, the searched content editing-related memo may be displayed in the form such as a text memo, a voice memo, or a thumbnail image.

According to one or more embodiments, in a state in which the searched content editing-related memo is displayed together with an image of the corresponding section of video data on which the searched content editing-related memo is tagged, in response to a selection of the image, the processor 220 (or the playback unit 332) may play back the corresponding section of the video data.

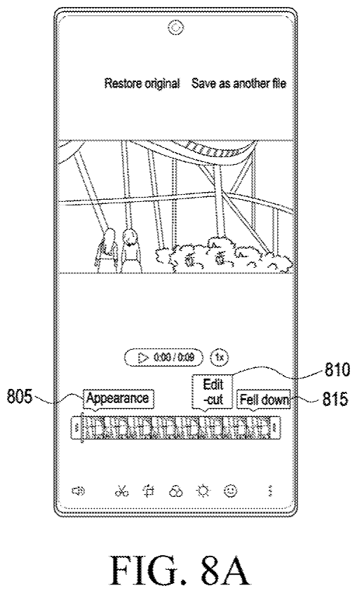

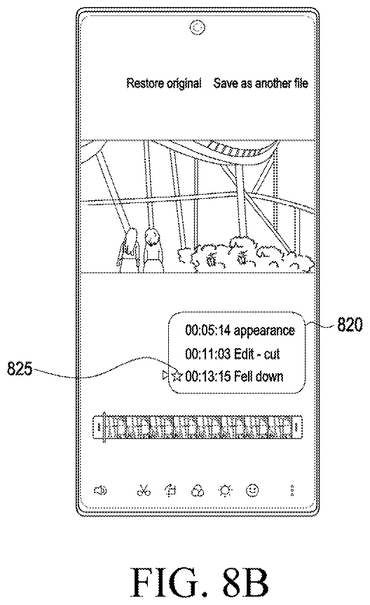

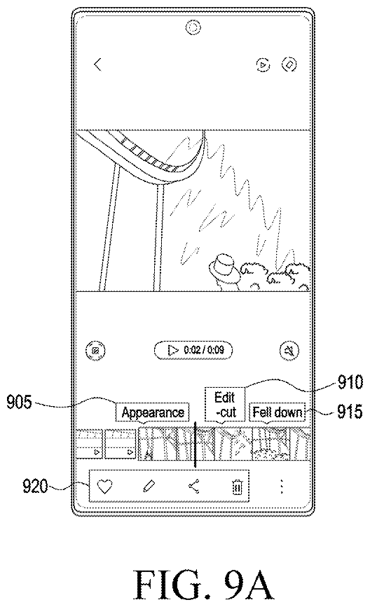

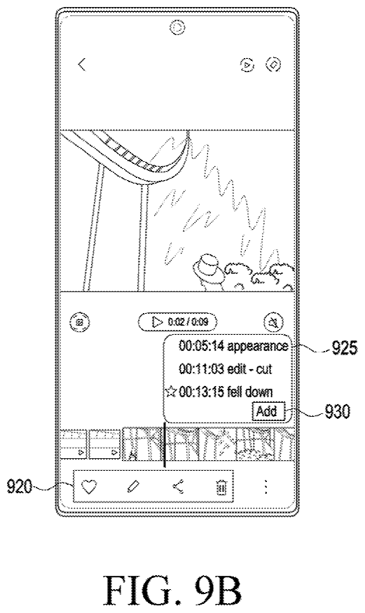

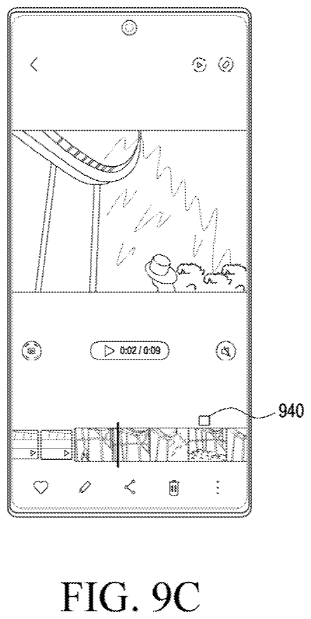

As described above, according to one or more embodiments, the user may conveniently search for, play back, or edit a desired content section using the content editing-related memo. Various forms of user interfaces for content searching, playback, or editing based on the content editing-related memo is described below with reference to FIGS. 8A to 9C.

According to one or more embodiments, the electronic device 101 may include a microphone 250, a camera 280, a processor 220, and memory 230. According to one or more embodiments, the memory may store instructions configured to, when executed by the processor, cause the electronic device to obtain video data through a camera. According to one or more embodiments, the instructions may be configured to cause the electronic device to obtain audio data through the microphone while obtaining the video data through the camera. According to one or more embodiments, the instructions may be configured to cause the electronic device to identify a user's voice from the audio data. According to one or more embodiments, the instructions may be configured to cause the electronic device to identify a memo associated with content editing, based on voice-recognized text for the user's voice. According to one or more embodiments, the instructions may be configured to cause the electronic device to store content including the video data, the audio data from which the user's voice has been removed, and the identified memo.

According to one or more embodiments, the instructions may be configured to cause the electronic device to identify a designated command from the user's voice, in response to identifying the designated command, identify a first section to be tagged among the video data, and tag the memo on the identified first section of the video data.

According to one or more embodiments, the instructions may be configured to cause the electronic device to identify a designated audio pattern among the audio data, in response to identifying the designated audio pattern, identify a second section to be tagged among the video data, and tag a memo associated with the designated audio pattern on the identified second section of the video data.

According to one or more embodiments, the instructions may be configured to cause the electronic device to detect a designated object or an action of a designated object in at least part of the video data, based on detecting the designated object or the action of the designated object, identify a third section to be tagged among the video data, and tag a memo associated with the designated object or the action of the designated object on the identified third section of the video data.

According to one or more embodiments, the instructions may be configured to cause the electronic device to perform voice recognition on the user's voice in response to receiving a designated touch input for content editing.

According to one or more embodiments, the instructions may be configured to cause the electronic device to identify a surrounding circumstance based on sensor data obtained by at least one sensor of the electronic device, in response to identifying the surrounding circumstance, identify a fourth section to be tagged among the video data, and tag a memo associated with the surrounding circumstance on the identified fourth section of the video data.

According to one or more embodiments, the instructions may be configured to cause the electronic device to analyze context of the voice-recognized text based on the voice-recognized text for the user's voice and generate the memo indicating the analyzed context.

According to one or more embodiments, the instructions may be configured to cause the electronic device to, after identifying the user's voice from the audio data, separate the audio data into audio data corresponding to the user's voice and audio data excluding the user's voice, and identify the designated audio pattern among the audio data excluding the user's voice.

According to one or more embodiments, the instructions may be configured to cause the electronic device to, in response to identifying the designated command, identify a speech section associated with content editing after the designated command, and identify the first section of the video data corresponding to the identified speech section.

According to one or more embodiments, the instructions may be configured to cause the electronic device to generate time information including a start time and/or an end time for the identified speech section and tag the generated time information and the memo on the identified first section of the video data.

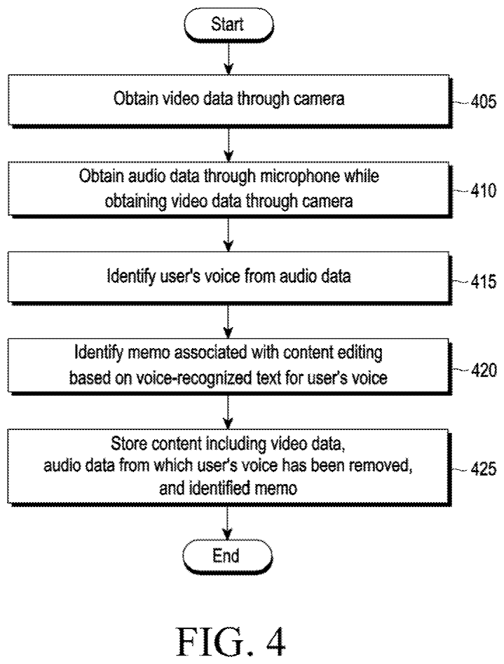

FIG. 4 is an operation flowchart of an electronic device for providing information related to content editing according to one or more embodiments. Referring to FIG. 4, an operating method may include operations 405 to 425. Each operation of the operating method of FIG. 4 may be performed by an electronic device (e.g., the electronic device 101 of FIGS. 1 and 2B) or at least one processor (e.g., the processor 120 of FIG. 1 and the processor 220 of FIG. 2B) of the electronic device. In one or more embodiments, at least one of operations 405 to 425 may be omitted, an order of some operations may be changed, or another operation may be added.

Referring to FIG. 4, when a camera application is selected by the user, in operation 405, the electronic device 101 may obtain video data through the camera 280. The electronic device 101 may display a preview image received through the camera 280 on a display.

In operation 410, the electronic device 101 may obtain audio data through a microphone while obtaining the video data through the camera.

In operation 415, the electronic device 101 may identify a user's voice from the audio data.

In operation 420, the electronic device 101 may identify a memo associated with content editing, based on voice-recognized text for the user's voice.

In operation 425, the electronic device 101 may store content including the video data, the audio data from which the user's voice has been removed, and the identified memo.

According to one or more embodiments, the electronic device 101 may identify a designated command from the user's voice. In response to identifying the designated command, the electronic device 101 may identify a first section to be tagged among the video data. The electronic device 101 may tag the memo on the identified first section of the video data.

According to one or more embodiments, the electronic device 101 may identify a designated audio pattern among the audio data. In response to identifying the designated audio pattern, the electronic device 101 may identify a second section to be tagged among the video data. The electronic device 101 may tag a memo associated with the designated audio pattern on the identified second section of the video data.

According to one or more embodiments, the electronic device 101 may detect a designated object or an action of a designated object in at least part of the video data. Based on detecting the designated object or the action of the designated object, the electronic device 101 may identify a third section to be tagged among the video data. The electronic device 101 may tag a memo associated with the designated object or the action of the designated object on the identified third section of the video data.

According to one or more embodiments, the electronic device 101 may perform voice recognition on the user's voice in response to receiving a designated touch input for content editing.

According to one or more embodiments, the electronic device 101 may identify a surrounding circumstance based on sensor data obtained by at least one sensor of the electronic device. In response to identifying the surrounding circumstance, the electronic device 101 may identify a fourth section to be tagged among the video data. The electronic device 101 may tag a memo associated with the surrounding circumstance on the identified fourth section of the video data.

According to one or more embodiments, based on voice-recognized text for the user's voice, the electronic device 101 may analyze context of the voice-recognized text and generate the memo indicating the analyzed context.

According to one or more embodiments, after identifying the user's voice from the audio data, the electronic device 101 may separate the audio data into audio data corresponding to the user's voice and audio data excluding the user's voice. The electronic device 101 may identify the designated audio pattern among the audio data excluding the user's voice.

According to one or more embodiments, in response to identifying the designated command, the electronic device 101 may identify a speech section associated with content editing after the designated command. The electronic device 101 may identify the first section of the video data corresponding to the identified speech section.

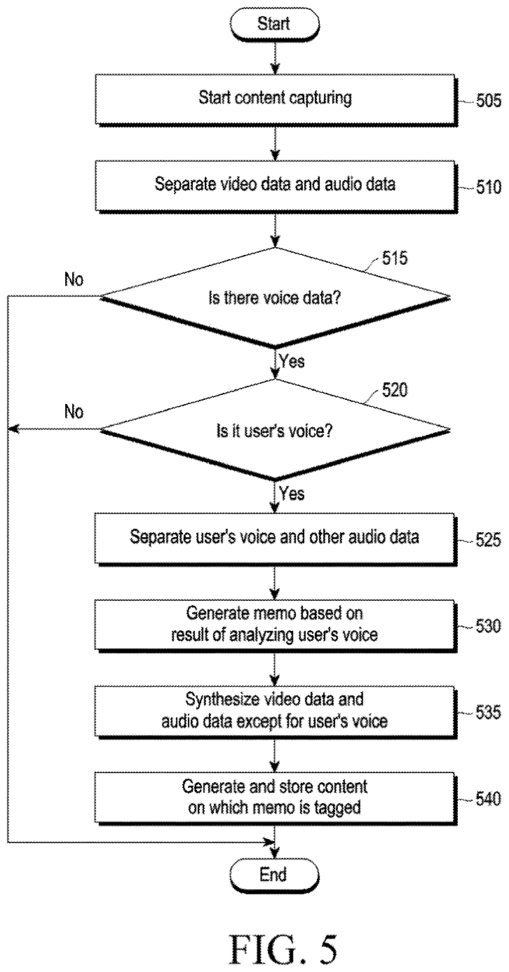

FIG. 5 is a detailed operation flowchart of an electronic device for providing information related to content editing according to one or more embodiments. Referring to FIG. 5, an operating method may include operations 505 to 540. Each operation of the operating method of FIG. 5 may be performed by an electronic device (e.g., the electronic device 101 of FIGS. 1 and 2B) or at least one processor (e.g., the processor 120 of FIG. 1 and the processor 220 of FIG. 2B) of the electronic device. In one or more embodiments, at least one of operations 505 to 540 may be omitted, an order of some operations may be changed, or another operation may be added.

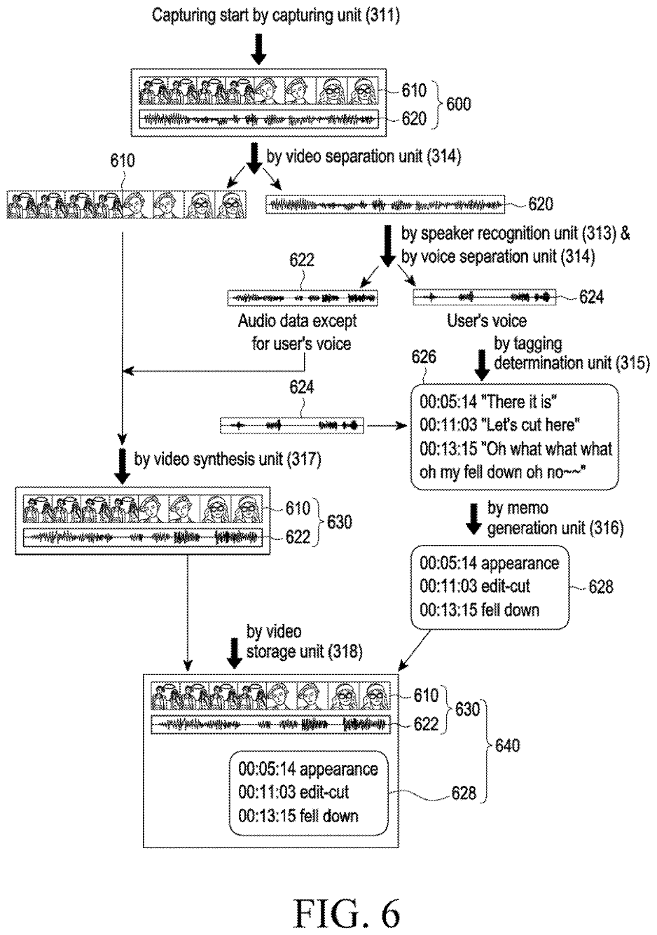

Hereinafter, the description of FIG. 5 is made with reference to FIG. 6 to aid understanding. FIG. 6 is a conceptual view illustrating one or more embodiments of generating and storing a memo related to editing based on a user's voice during content capturing according to one or more embodiments.

In operation 505, the electronic device 101 may start content capturing (or recording) according to the execution of a camera application (e.g., the camera application 310 of FIG. 3).

In operation 510, the electronic device 101 may separate video data and audio data according to content capturing. For example, referring to FIG. 6, when capturing is started by the capturing unit 311, the electronic device 101 may receive video data 610 obtained through the camera 280 and audio data 620 through the microphone 250. During content capturing, the captured data 600 may be separated into the video data 610 and the audio data 620 by the video separation unit 314.

In operation 515, the electronic device 101 may identify whether there is voice data. For example, the speaker recognition unit 313 may detect whether voice data corresponding to a person's voice is included in audio data (or a voice signal) received through the microphone 250. When there is no voice data, the electronic device 101 may continue to display a preview image according to the camera application execution through a display, but may not initiate an operation for providing a content editing-related memo based on voice content.

On the other hand, when voice data corresponding to a person's voice is identified, the electronic device 101 may identify, in operation 520, whether the voice is the user's voice using a voice recognition engine. For example, the speaker recognition unit 313 may determine whether the identified voice data is data corresponding to the user's voice by comparing the voice data with voice data pre-stored in the memory 230. However, if voice data corresponding to a person's voice is not identified, the electronic device 101 may not initiate an operation for providing a content editing-related memo based on voice content.

In response to identifying the user's voice, the electronic device 101 may, in operation 525, separate the user's voice and other audio data. According to one or more embodiments, the electronic device 101 may extract audio data corresponding to the user's voice from audio data received through the microphone 250. For example, the voice separation unit 314 may separate the audio data 620 received through the microphone 250 into audio data 624 corresponding to the user's voice and remaining audio data 622 except for the user's voice.

In operation 530, the electronic device 101 may generate a memo based on a result of analyzing the user's voice.

According to one or more embodiments, the electronic device 101 may perform voice recognition through a voice recognition engine (or a voice recognition module, a voice recognition model) stored in the memory 230.

According to one or more embodiments, the electronic device 101 may obtain voice-recognized text for at least part of data uttered by the user. For example, using a voice recognition engine, the electronic device 101 may understand the meaning of a word extracted from a voice input using linguistic features (e.g., grammatical elements) of a morpheme or a phrase and may determine the user's intent by matching the understood meaning of the word to an intent. By determining the intent corresponding to the voice in this way, the meaning of the user's utterance may be extracted.

For example, referring to FIG. 6, the tagging determination unit 315 may identify whether voice-recognized text such as “There it is” is content requiring tagging, and if it is determined that tagging is required, the tagging determination unit 315 may provide time information (e.g., “00:05:14”) and text “There it is” of the voice section to the memo generation unit 316. Further, for voice-recognized text such as “Let's cut here”, the tagging determination unit 315 may provide time information (e.g., “00:11:03”) and text “Let's cut here” of the voice section to the memo generation unit 316. Further, based on voice-recognized text such as “Oh what what what oh my fell down oh no”, the tagging determination unit 315 may provide time information (e.g., “00:13:15”) and text “Oh what what what oh my fell down oh no” of the voice section to the memo generation unit 316.

As described above, based on a result of analyzing the voice-recognized text 626 for the user's voice, the electronic device 101 may generate a memo 628 summarizing the content of the user's utterance.

For example, based on the voice-recognized text “There it is”, the electronic device 101 may generate a memo “appearance”. Further, based on the voice-recognized text “Let's cut here”, the electronic device 101 may generate a memo “edit-cut”. Further, based on the voice-recognized text “Oh what what what oh my fell down oh no”, the electronic device 101 may generate a memo “fell down”. Meanwhile, in one or more embodiments, a case of generating a memo summarizing the utterance content based on the voice-recognized text 626 is described as an example, but the method of generating a memo may not be limited thereto. For example, a memo may be generated based on a keyword included in voice-recognized text or a first recognized word, and it is apparent to those skilled in the art that the method of determining the content included in the memo may vary.

According to one or more embodiments, as illustrated in FIG. 6, the electronic device 101 may generate time information including a start time of a voice section in which the user uttered from the voice-recognized text 626.

According to one or more embodiments, the electronic device 101 may generate time information including a start time and/or an end time of a voice section in which the user uttered from the voice-recognized text 626. The electronic device 101 may associate the time information with the generated memo. As such, the time information may be a record of a start time and/or an end time when the user's voice starts, may represent a time section between the start time and the end time, and may be-n/+n seconds based on the start time. Therefore, it is apparent to those skilled in the art that the time information may be configured in various ways.

In operation 535, the electronic device 101 may synthesize video data and audio data except for the user's voice. According to one or more embodiments, the electronic device 101 (e.g., the video synthesis unit 317) may combine video data obtained through the camera 280 and remaining audio data except for audio data corresponding to the user's voice among audio data received through the microphone 250 into one file form through synthesis. According to one or more embodiments, the electronic device 101 may generate a file in which only audio data 624 corresponding to the user's voice is excluded from the captured data 600.

In operation 540, the electronic device 101 (e.g., the video storage unit 318) may generate and store content on which the memo is tagged. For example, as illustrated in FIG. 6, the electronic device 101 may synthesize or combine the video data 610 and the audio data 622 except for the user's voice and may store the content in the memory 230 in the form of one file 640 in which the content editing-related memo 628 is tagged on the corresponding section of the synthesized or combined data 630. Therefore, when a voice signal corresponding to a user's utterance is input through the microphone 250 while a preview image is displayed through the display 260, the electronic device 101 may tag and store a memo summarizing the user voice content while capturing a video currently displayed on the screen. Here, before storing the data on which the memo summarizing the user voice content is tagged, i.e., the content, the electronic device 101 may tag and store time information including a start time and/or an end time when the user's voice started together.

According to one or more embodiments, when the user utters multiple times during content capturing, a plurality of memos may be generated based on a result of analyzing the voice section. Therefore, the electronic device 101 may associate time information of the corresponding voice section with each generated memo.

According to one or more embodiments, the electronic device 101 may perform an operation of analyzing the meaning of a voice section for audio data input through the microphone 250 at regular time intervals during content capturing and generating a user voice-based memo based on a result of analyzing the voice section. Accordingly, the voice recognition engine may sample audio data input at preset time periods and analyze voice-recognized text.

According to one or more embodiments, when recognizing a designated command (e.g., a wake-up word (e.g., “hi bixby”)) during capturing, the electronic device 101 may initiate an operation of generating a user voice-based memo.

According to one or more embodiments, the electronic device 101 may analyze the meaning of a voice section during content capturing and, when recognizing a designated voice input (e.g., “Wake up!”, “Start”) in a result of analyzing the voice section, the electronic device 101 may initiate an operation of generating a user voice-based memo.

According to one or more embodiments, when receiving a designated touch input for content editing or an input through a hardware key (e.g., a dedicated hardware key), the electronic device 101 may initiate an operation of generating a user voice-based memo. For example, when an object (e.g., an icon) for executing voice recognition is displayed on a capturing screen and the object is selected, the electronic device 101 may drive a voice recognition engine to initiate voice recognition. Further, when the selection of the object is released, the electronic device 101 may stop the voice recognition. Further, while an input through a hardware key (e.g., a dedicated hardware key) is maintained, the electronic device 101 may perform an operation of generating a user voice-based memo and may stop the voice recognition when the key input is released. In this case, when a user input such as a designated command input or a touch input is received, as the voice recognition engine is driven, the voice recognition engine may sample audio data input at preset time periods and analyze voice-recognized text. When the voice-recognized text is in a sentence form, the electronic device 101 may extract a user intent represented by the sentence and generate a memo in the form of a word or a short note.

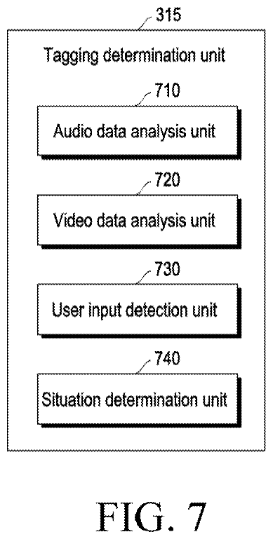

FIG. 7 is a view illustrating a component for determining a condition for tagging information related to content editing according to one or more embodiments.

Referring to FIG. 7, the tagging determination unit 315 may include an audio data analysis unit 710, a video data analysis unit 720, a user input detection unit 730, or a circumstance determination unit 740.

According to one or more embodiments, to determine data requiring tagging and a tagging time, the audio data analysis unit 710 may analyze data obtained by converting the user's voice into text and may identify whether a circumstance requiring tagging is present using the analyzed data. Further, the audio data analysis unit 710 may identify a designated audio pattern among audio data corresponding to the user's voice or audio data except for the user's voice. For example, if an audio pattern such as a cough sound or a vehicle collision sound is identified, it may be identified that a circumstance requiring tagging is present.

The video data analysis unit 720 may analyze at least one video frame included in the content and may identify whether a circumstance requiring tagging is present based on a result of analyzing the video frame. For example, a circumstance requiring tagging may be identified based on a scene recognition result value such as ‘birthday party’ or ‘happy expression’, a scene understanding result value such as ‘a scene illustrating a clock’ or ‘a cloudy sky scene’, a person detection and analysis result value such as ‘a scene with person A and person B’ or ‘actor C appearance’, or a result value obtained by analyzing a capturing environment such as ‘brightness of the scene changes by a threshold or more’.

The user input detection unit 730 may identify that a circumstance requiring tagging is present when a user input through a designated touch input or a hardware key (e.g., a dedicated hardware key) is received.

The circumstance determination unit 740 may identify a circumstance requiring tagging based on a circumstance analysis result value. For example, when a circumstance such as the user starting to run or capturing at the entrance of an amusement park is recognized, the circumstance determination unit 740 may identify that a circumstance requiring tagging is present.

The tagging determination unit 315 may generate time information (e.g., a timestamp) related to a time when tagging is determined.

For example, when recognizing a designated command (e.g., a wake-up word (e.g., “hi bixby”)) during capturing, the tagging determination unit 315 may generate time information including a start time when the designated command was uttered and/or a time when the user's utterance ended (e.g., end-point detection, EPD). The time information may include an utterance start time, an utterance end time, or a time section between the utterance start time and the utterance end time, and may be-n/+n seconds based on the utterance start time.

For example, when recognizing a designated voice input (e.g., “Wake up!”, “Start”), the tagging determination unit 315 may generate time information including a start time and/or an end time of a voice section input after the designated voice input.

For example, when receiving a designated touch input for content editing or an input through a hardware key (e.g., a dedicated hardware key), the tagging determination unit 315 may generate time information including a press time and a release time of the touch input or the hardware key.

For example, when a designated audio pattern is identified among audio data, the tagging determination unit 315 may generate time information including a start time and/or an end time of a section corresponding to the designated audio pattern.

For example, when a scene requiring tagging is identified among video data, the tagging determination unit 315 may generate time information including a time when a first video frame of the identified time was obtained and/or a time when a last video frame was obtained.

For example, the tagging determination unit 315 may generate time information including a time when sensor data used to identify a surrounding circumstance requiring tagging was obtained.

As described above, the tagging determination unit 315 may generate time information including a start time when tagging is determined to be required, and in some cases, the first start time of data requiring tagging may be required, and in some cases, the last end time of data requiring tagging may be required. Therefore, the tagging determination unit 315 may provide time information including start time and/or end time information related to a time when a circumstance requiring tagging is determined.

FIG. 8A is a screen example view for describing a first method of displaying a memo associated with content editing according to one or more embodiments, and FIG. 8B is a screen example view for describing a second method of displaying a memo associated with content editing according to one or more embodiments.

FIGS. 8A and 8B illustrate an example of providing information about a time indicated by a memo associated with content editing. Referring to FIG. 8A, when a menu for viewing stored content is selected by the user, the electronic device 101 may display using a preset object to indicate that a memo summarizing the user voice content is tagged on the stored content.

According to one or more embodiments, the electronic device 101 may enter the content editing mode in response to the content editing request. For example, when an input by an execution icon (e.g., an object, a graphic element, a menu, a button, or a shortcut image) (not illustrated) representing an application for content editing or a selection input for an editing menu on a content playback screen is received, the electronic device 101 may identify that there is an editing request. In response to the request, the electronic device 101 may execute the video editing application 320 or enter a content editing mode. According to the execution of the video editing application 320 or in the content editing mode, the electronic device 101 may provide a function enabling content to be edited on a content playback screen (or a preview screen).

For example, in the content editing mode, in a state in which video frames are displayed along a timeline, memos 805, 810, and 815 tagged on the corresponding time or section may be displayed.

Referring to FIG. 8B, instead of displaying the video frame and the memo along the timeline, the electronic device 101 may display the video frame and the memo in the form of one list 820. For example, the electronic device 101 may display the memo content of FIG. 8A in the form of one memo on at least part of a content editing screen regardless of the timeline. In this case, the content of a memo 825 bookmarked by the user may be marked using a designated object (e.g., a star shape) or a designated color.

In FIG. 8A, a case in which a memo tagged on the corresponding section of the video frame is displayed is illustrated, but in FIG. 8B, a section corresponding to the tagged memo of the video frame, i.e., a section corresponding to time information stored together with the memo may be visually provided. For example, the electronic device 101 may provide a section of the video frame corresponding to the time-tagged memo by processing the section with a designated display effect (e.g., dimming processing, blinking processing, or blur processing). The user may identify the displayed section among a plurality of video frames, and the electronic device 101 may perform editing (e.g., deletion) on the displayed section according to the user's selection.

To visually indicate which portion of the video frame requires editing and with what content, the electronic device 101 may represent an object (or a graphic element, a symbol) representing the memo on a section on which the memo is tagged using different colors or different shapes.

According to one or more embodiments, the memos 805, 810, and 815 may be classified according to the characteristics of the memo and may be displayed in different shapes according to the classification. For example, the marking method of the memo may vary according to predefined rules such as a related person (a person appearing/a person capturing), a use purpose (editing/viewing/searching), or a source of information (inside the screen/outside the screen/other information). For example, a memo about a person appearing on the screen may be marked in black, and a memo about the user may be marked in blue. Further, a memo about content may be marked in text, and a memo about editing may be marked in a speech bubble shape.

When the memo content is modified by the user or a portion of a section of the video frame is modified, the electronic device 101 may display a result to which the modification has been applied in a preview form. Further, when editing completion is selected by the user, the electronic device 101 may store the edited content.

The electronic device 101 may support a function of searching for a desired scene or section based on a content editing-related memo. For example, when a search word is input by the user in a state in which the gallery application 330 is executed, the electronic device 101 may search for a content editing-related memo corresponding to the input search word. If a content editing-related memo is searched, the search result may be displayed together with an indicator indicating a section on which the content editing-related memo is tagged. For example, the memo content may be displayed on a screen together with an image of the corresponding section of video data on which the searched content editing-related memo is tagged. Here, the searched content editing-related memo may be displayed in the form such as a text memo, a voice memo, or a thumbnail image.

If video data searched by the user is selected, the electronic device 101 may play back the selected video data from the start time of the time information based on time information tagged together with the memo.

For example, in a state in which the gallery application 330 is executed, when text such as ‘Hong Gil-dong presentation’ is input by the user, the electronic device 101 may provide a portion of a video frame corresponding to a tag ‘Hong Gil-dong presentation start’ stored in a tag as a search result. The thumbnail of the video frame corresponding to the search result may be an image frame of a start time of the ‘Hong Gil-dong presentation’ tag. If the thumbnail is selected by the user, the electronic device 101 may play back the content from the start time of the ‘Hong Gil-dong presentation’ tag.

For example, in a state in which the gallery application 330 is executed, when text such as ‘A birthday party’ is received in a search word, the electronic device 101 may provide a portion of the corresponding video frame as a search result based on a tag ‘A party attendees: person B, person C’ stored in a tag. The thumbnail of the video frame corresponding to the search result may be an image frame of a start time of the tag ‘A party attendees: person B, person C’. Here, because the time information of the image frame is designated based on a first image frame in which B is detected through person analysis, a face thumbnail of person B may be displayed. Further, when the thumbnail is selected, the electronic device 101 may play back the content from the start time of the time information of the tag ‘A party attendees: person B, person C’.

FIG. 9A is a screen example view for describing a first method of modifying a memo associated with content editing according to one or more embodiments, FIG. 9B is a screen example view for describing a second method of modifying a memo associated with content editing according to one or more embodiments, and FIG. 9C is a screen example view for describing a third method of modifying a memo associated with content editing according to one or more embodiments.

Referring to FIG. 9A, on a preview screen of the content, the electronic device 101 may display memos (or memo speech bubbles) 905, 910, and 915 tagged on the corresponding section of the video frame along a timeline. The electronic device 101 may provide a menu 920 enabling editing of the video frame. In FIG. 9A, a tagged memo (or a memo speech bubble) in text is illustrated as an example, but this is merely an example, time information (e.g., a timestamp) may be displayed without text, time information may be displayed together with a text memo, and a method of displaying a tagged memo may vary.

Further, as illustrated in FIG. 9B, the electronic device 101 may display in the form of one memo list 925 regardless of the timeline, or as illustrated in FIG. 9C, may display only a bookmarked portion 940.

Referring to FIGS. 9A to 9C, when a tagged memo (or a memo speech bubble) 905, 910, or 915, a memo list 925, or a bookmark item 940 is selected, the electronic device 101 may play back corresponding video data based on time information associated with the tagged memo. Further, when an add item 930 is selected as in FIG. 9B, the electronic device 101 may display a screen for inputting a time to be added and memo content, through which the user may add a memo. As described above, the electronic device 101 may visually display a memo tagged on the corresponding section of video data using various objects (or graphic elements).

Objects of the disclosure are not limited to the foregoing, and other unmentioned objects would be apparent to one of ordinary skill in the art.

Effects obtainable from the disclosure are not limited to the above-mentioned effects, and other effects not mentioned may be apparent to one of ordinary skill in the art.

All of the embodiments of the disclosure described herein are example embodiments, and thus, the disclosure is not limited thereto, and may be realized in various other forms. Each of the embodiments provided in the following description is not excluded from being associated with one or more features of another example or another embodiment also provided herein or not provided herein but consistent with the disclosure.

The embodiments of the disclosure described in the present specification and the drawings are only presented as specific examples to easily explain the technical content according to the embodiments of the disclosure and help understanding of the embodiments of the disclosure, not intended to limit the scope of the embodiments of the disclosure. Therefore, the scope of one or more embodiments of the disclosure should be construed as encompassing all changes or modifications derived from the technical spirit of one or more embodiments of the disclosure in addition to the embodiments disclosed herein.

In this disclosure, the terms “containing”, “including”, “comprising”, “having”, and the like are used to specify features, numbers, steps, operations, elements, components, or combinations thereof, but do not preclude the presence or addition of one or more of the features, numbers, steps, operations, elements, components, or combinations thereof.

In addition, in the present disclosure, the meaning of “identical” includes cases where properties are similar to each other or similar within a certain range. Furthermore, unless clearly indicated, stated, and/or shown otherwise; as used herein the terms “identical”, “uniform”, “equal”, and/or “the same” may mean “substantially identical”, “substantially uniform”, “substantially equal”, “about the same”, “equal to about”, and/or “substantially the same”. The meaning of substantially identical should be understood to include numerical values within manufacturing error ranges, machining or processing tolerances, and/or differences within a range that is so insignificant such that neither the structure nor function of the embodiments disclosed herein are materially altered, inhibited, or destroyed.

Unless otherwise indicated, as used herein with regard to any plurality of a particular type of component, any two components of that type may be considered “adjacent” or “adjacent to” one another so long as no other component of that type occupies a space between the two components. For example, the two components may be considered adjacent each other if the two components are not separated from each other by an intervening component of that type.

Furthermore, although one or more embodiments may comprise the disclosed features as described herein—as well as additional features not specifically described—other embodiments may instead be completely free of non-disclosed elements. For example, non-disclosed elements may be completely omitted from one or more embodiments of the present disclosure.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to one or more embodiments of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to one or more embodiments, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to one or more embodiments, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component.

In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

According to one or more embodiments, in a non-transitory storage medium storing instructions, the instructions are configured to, when executed by at least one processor 120, 220 of an electronic device 101, cause the electronic device to perform at least one operation, and the at least one operation may include an operation of obtaining video data through a camera. According to one or more embodiments, the at least one operation may include an operation of obtaining audio data through a microphone while obtaining the video data through the camera. According to one or more embodiments, the at least one operation may include an operation of identifying a user's voice from the audio data. According to one or more embodiments, the at least one operation may include an operation of identifying a memo associated with content editing, based on voice-recognized text for the user's voice. According to one or more embodiments, the at least one operation may include an operation of storing content including the video data, the audio data from which the user's voice has been removed, and the identified memo.

One or more embodiments of the present disclosure may provide an electronic device, wherein the instructions are further configured to cause the electronic device to: identify a designated command associated with the voice, identify, in response to identifying the designated command, a first section of the video data to be tagged, and tag the memo on the first section of the video data.

One or more embodiments of the present disclosure may provide an electronic device, wherein the instructions are further configured to cause the electronic device to: identify a designated audio pattern among the audio data, identify, in response to identifying the designated audio pattern, a second section of the video data to be tagged, and tag a memo associated with the designated audio pattern on the second section of the video data.

One or more embodiments of the present disclosure may provide an electronic device, wherein the instructions are further configured to cause the electronic device to: detect a designated object or an action of a designated object in at least part of the video data, identify, based on detecting the designated object or the action of the designated object, a third section of the video data to be tagged, and tag, on the third section of the video data, a memo associated with the designated object or the action of the designated object.

One or more embodiments of the present disclosure may provide an electronic device, wherein the instructions are further configured to cause the electronic device to: perform, in response to receiving a designated touch input for content editing, voice recognition of the voice.

One or more embodiments of the present disclosure may provide an electronic device, wherein the instructions are further configured to cause the electronic device to: identify, based on sensor data obtained by at least one sensor of the electronic device, a surrounding situation, identify, in response to identifying the surrounding situation, a fourth section of the video data to be tagged, and tag, on the fourth section of the video data, a memo associated with the surrounding situation.

One or more embodiments of the present disclosure may provide an electronic device, wherein the instructions are further configured to cause the electronic device to: analyze, based on the voice-recognized text, context associated with the voice-recognized text, and generate the memo indicating the analyzed context.

One or more embodiments of the present disclosure may provide an electronic device, wherein the instructions are further configured to cause the electronic device to: separate, after identifying the voice from among the audio data, the audio data into: audio data corresponding to the voice, and audio data excluding the voice, and identify the designated audio pattern among the audio data excluding the voice.

One or more embodiments of the present disclosure may provide an electronic device, wherein the instructions are further configured to cause the electronic device to: identify, in response to identifying the designated command, a speech section associated with content editing, and identify the first section of the video data corresponding to the speech section.

One or more embodiments of the present disclosure may provide an electronic device, wherein the instructions are further configured to cause the electronic device to: generate time information including a start time of the speech section and/or an end time of the speech section, and tag, on the first section of the video data, the generated time information and the memo.

One or more embodiments of the present disclosure may provide a method, further including: identifying a designated command associated with the voice; identifying, in response to identifying the designated command, a first section of the video data to be tagged; and tagging the memo on the first section of the video data.

One or more embodiments of the present disclosure may provide a method, further including: identifying a designated audio pattern among the audio data; identifying, in response to identifying the designated audio pattern, a second section to be tagged among the video data; and tagging, on the second section of the video data, a memo associated with the designated audio pattern.

One or more embodiments of the present disclosure may provide a method, further including: detecting a designated object or an action of a designated object in at least part of the video data; identifying, based on detecting the designated object or the action of the designated object, a third section of the video data to be tagged; and tagging, on the third section of the video data, a memo associated with the designated object or the action of the designated object.

What is claimed is:

1. An electronic device comprising:
a microphone;
a camera;
at least one processor; and
memory storing instructions configured to, when executed by the at least one processor individually or collectively, cause the electronic device to:
obtain, using the camera, video data,
obtain, using the microphone, audio data while obtaining the video data,
identify, based on the audio data, a voice associated with a user,
identify, based on voice-recognized text associated with the voice, a memo associated with content editing, and
store content that includes:
the video data,
the audio data from which the voice has been removed, and
the memo.

2. The electronic device of claim 1, wherein the instructions are further configured to cause the electronic device to:
identify a designated command associated with the voice,
identify, in response to identifying the designated command, a first section of the video data to be tagged, and
tag the memo on the first section of the video data.

3. The electronic device of claim 2, wherein the instructions are further configured to cause the electronic device to:
identify a designated audio pattern among the audio data,
identify, in response to identifying the designated audio pattern, a second section of the video data to be tagged, and
tag a memo associated with the designated audio pattern on the second section of the video data.

4. The electronic device of claim 3, wherein the instructions are further configured to cause the electronic device to:
detect a designated object or an action of a designated object in at least part of the video data,
identify, based on detecting the designated object or the action of the designated object, a third section of the video data to be tagged, and
tag, on the third section of the video data, a memo associated with the designated object or the action of the designated object.

5. The electronic device of claim 1, wherein the instructions are further configured to cause the electronic device to:
perform, in response to receiving a designated touch input for content editing, voice recognition of the voice.

6. The electronic device of claim 4, wherein the instructions are further configured to cause the electronic device to:
identify, based on sensor data obtained by at least one sensor of the electronic device, a surrounding situation,
identify, in response to identifying the surrounding situation, a fourth section of the video data to be tagged, and
tag, on the fourth section of the video data, a memo associated with the surrounding situation.

7. The electronic device of claim 1, wherein the instructions are further configured to cause the electronic device to:
analyze, based on the voice-recognized text, context associated with the voice-recognized text, and
generate the memo indicating the analyzed context.

8. The electronic device of claim 3, wherein the instructions are further configured to cause the electronic device to:
separate, after identifying the voice from among the audio data, the audio data into:
audio data corresponding to the voice, and
audio data excluding the voice, and
identify the designated audio pattern among the audio data excluding the voice.

9. The electronic device of claim 2, wherein the instructions are further configured to cause the electronic device to:
identify, in response to identifying the designated command, a speech section associated with content editing, and
identify the first section of the video data corresponding to the speech section.

10. The electronic device of claim 9, wherein the instructions are further configured to cause the electronic device to:
generate time information including a start time of the speech section and/or an end time of the speech section, and
tag, on the first section of the video data, the generated time information and the memo.

11. A method for providing information related to content editing in an electronic device, the method comprising:
obtaining, using a camera, video data;
obtaining, using a microphone, audio data while obtaining the video data;
identifying, based on the audio data, a voice associated with a user;
identifying, based on voice-recognized text associated with the voice, a memo associated with content editing; and
storing content that includes:
the video data,
the audio data from which the voice has been removed, and
the memo.

12. The method of claim 11, further comprising:
identifying a designated command associated with the voice;
identifying, in response to identifying the designated command, a first section of the video data to be tagged; and
tagging the memo on the first section of the video data.

13. The method of claim 12, further comprising:
identifying a designated audio pattern among the audio data;
identifying, in response to identifying the designated audio pattern, a second section to be tagged among the video data; and
tagging, on the second section of the video data, a memo associated with the designated audio pattern.

14. The method of claim 13, further comprising:
detecting a designated object or an action of a designated object in at least part of the video data;
identifying, based on detecting the designated object or the action of the designated object, a third section of the video data to be tagged; and
tagging, on the third section of the video data, a memo associated with the designated object or the action of the designated object.

15. A non-transitory storage medium storing instructions configured to, when executed by at least one processor that is communicatively coupled with an electronic device, cause the electronic device to perform at least one operation, wherein the at least one operation includes:
obtaining, using a camera, video data;
obtaining, using a microphone, audio data while obtaining the video data;
identifying, based on the audio data, a voice associated with a user;
identifying, based on voice-recognized text associated with the voice, a memo associated with content editing; and
storing content that includes:
the video data,
the audio data from which the voice has been removed, and
the memo.
